(19) United States
(12) Patent Application Publication
(10) Pub. No.: US 2021/0025384 A1
(43) Pub. Date: Jan. 28, 2021

(54) ELASTIC PISTON AND HIGH-PRESSURE PUMPING SYSTEM

(71) Applicant: HUIZHOU HYDRO CARESYS MEDICAL CO., LTD., Huizhou (CN)

(72) Inventor: Fengling LUO, Huizhou (CN)

(21) Appl. No.: 16/991,395

(22) Filed: Aug. 12, 2020

Related U.S. Application Data
(63) Continuation of application No. PCT/CN2018/125085, filed on Dec. 28, 2018.

(30) Foreign Application Priority Data
Feb. 12, 2018 (CN) 201810147884.1
Mar. 15, 2018 (CN) 201810217293.7

(51) Int. Cl. F04B 53/14; F04B 19/22

(52) U.S. Cl. CPC F04B 53/14; F04B 19/22

(57) ABSTRACT

A piston and a high-pressure pumping system. The piston includes a piston body and a skirt. The skirt is elastic and peripherally provided at an end of the piston body. The skirt elastically abuts against an inner wall of a cylinder chamber when the piston is placed in the cylinder chamber. The high-pressure pumping system includes a cylinder and the piston. The piston is received in the cylinder and reciprocates with respect to the inner wall of the cylinder chamber.

### CROSS-REFERENCE TO RELATED APPLICATIONS

This application is a continuation of International Patent Application No. PCT/CN2018/125085, filed on Dec. 28, 2018, which claims the benefit of priority from Chinese Patent Application No. 201810147884.1, filed on Feb. 12, 2018; and No. 201810217293.7, filed on Mar. 15, 2018. The content of the aforementioned applications, including any intervening amendments thereto, is incorporated herein by reference in its entirety.

### TECHNICAL FIELD

The present application relates to medical equipment, and more particularly to a piston and a high-pressure pumping system.

### BACKGROUND

A piston in a medical high-pressure pumping system is generally cylindrical. The piston is slidably received in a cylinder chamber and reciprocates to supply power for pumping fluid into and out of the pump chamber. The reciprocating motion of the piston has two directions: forward and reverse. The fluid is pumped out of the pump chamber due to the forward movement of the piston, and the fluid is sucked into the pump chamber due to the reverse movement of the piston. When the piston is in the reverse movement, a negative pressure difference is formed between the interior and exterior of the pump chamber. Under the action of the negative pressure difference, water flows into the pump chamber, and if there is a tiny gap between the piston and the cylinder wall, air goes into the pump chamber, which leads to bubbles in high-pressure water pipelines. Air has great compressibility under high pressure, and air gathers around an inlet valve or an outlet valve in the pump body, which seriously affects the opening and closing characteristics of the inlet valve or outlet valve, such that the high-pressure water flow impacts weakest parts of the pipeline, thereby changing the pressure bearing performance of the entire pump body and leading to increased accident risk.

### SUMMARY

The present application aims to provide a piston and a high-pressure pumping system.

The technical solutions of the present application are described as follows.

In a first aspect, the present application provides a piston, comprising a piston body and a skirt;

wherein the skirt is elastic and peripherally provided at an end of the piston body; and the skirt elastically abuts against an inner wall of a cylinder chamber when the piston is placed in the cylinder chamber.

The present application has the following technical effects.

A skirt provided on the piston body elastically abuts against the inner wall of the cylinder chamber. Under the elastic force, the skirt can consistently and adaptively fit with the inner wall of the cylinder chamber to create good sealing during the reciprocating movement of the piston body in the cylinder chamber, so that air is not able to enter the cylinder chamber to mix with the fluid therein during the reciprocating movement of the piston body, thereby improving the operation stability and the service life of the high-pressure pumping system and reducing failure risk during the operation.

In a second aspect, the present application provides a high-pressure pumping system, comprising a cylinder and the piston;

wherein the piston is received in the cylinder and reciprocates with respect to the inner wall of the cylinder chamber; and the skirt elastically abuts against the inner wall of the cylinder chamber when the piston is placed in the cylinder chamber.

In the present application, the high-pressure pumping system uses the piston of the present application to realize good sealing during the operation of the high-pressure pumping system, and the air is stopped from entering the cylinder chamber to mix with the fluid therein, thereby improving the operation stability and the service life of the high-pressure pumping system and reducing failure risk during the operation.

### BRIEF DESCRIPTION OF THE DRAWINGS

FIG. 1 schematically shows a piston according to an embodiment of the present application.

FIG. 2 is a cross-sectional view of the piston of FIG. 1.

FIG. 3 is a partial cross-sectional view of a high-pressure pumping system according to an embodiment of the present application.

FIG. 4 is a partial enlarged view of Detail M in FIG. 3.

In the drawings: 10, piston body; 11, outer wall of piston body; 12, pressure chamber; 13, third inclined surface; 111, second inclined surface; 112, first inclined surface; 20, skirt; 21, first protruding surface; 22, second protruding surface; 30, cylinder; 31, cylinder chamber; 32, inner wall of cylinder chamber; 40, gap; C, first angle; G, second angle; A, third angle; H, thickness; and B, width.

### DETAILED DESCRIPTION OF EMBODIMENTS

The present application will be further described below in detail with reference to the accompanying drawings and the embodiments. The following embodiments are illustrative and not intended to limit the scope of the present application.

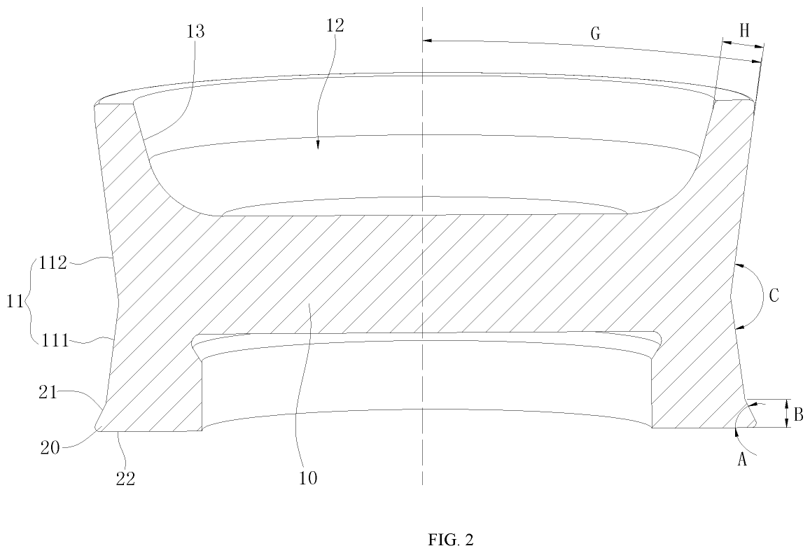

Provided herein is a piston, as shown in FIGS. 2-4. The piston includes a piston body 10 and a skirt 20. The skirt 20 is elastic and peripherally provided at an end of the piston body 10. The skirt 20 elastically abuts against an inner wall 32 of a cylinder chamber 31 when the piston is placed in the cylinder chamber 31 of a cylinder 30.

In the present embodiment, the skirt 20 elastically abuts against the inner wall 32 of the cylinder chamber 31, so that the skirt 20 can consistently and adaptively fit with the inner wall 32 of the cylinder chamber 31 under the elastic force to create good sealing during the reciprocating movement of the piston body 10 in the cylinder chamber 31, and thus air is not able to enter the cylinder chamber 31 to mix with the fluid therein during the reciprocating movement of the piston body 10, thereby improving the operation stability and the service life of the high-pressure pumping system and reducing failure risk during the operation.

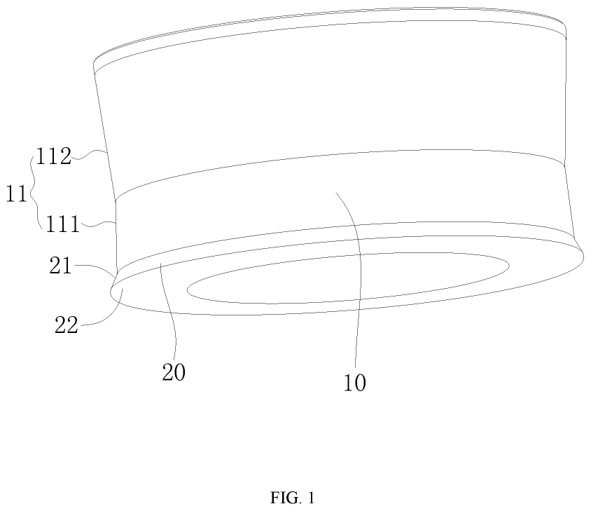

In an embodiment, as shown in FIGS. 1, 2 and 4, the piston body 10 is elastic. An outer wall 11 of the piston body 10 includes a first inclined surface 112. The skirt 20 has a first protruding surface 21. An end of the first protruding surface 21 is connected to an end of the first inclined surface 112. The other end of the first protruding surface 21 obliquely extends outwards along a radial direction of the piston body 10. The other end of the first inclined surface 112 obliquely extends outwards along the radial direction of the piston body 10, so that the first protruding surface 21 and the first inclined surface 112 are arranged in a shape of V, that is, a connecting end of the first protruding surface 21 and the first inclined surface 112 is concave toward a central axis of the piston body 10. Ends of the first protruding surface 21 and the first inclined surface 112 away from each other elastically abut against the inner wall 32 of the cylinder chamber 31. Thus, the piston body 10 can reciprocate in the cylinder chamber 31 while good sealing is formed between the first protruding surface 21 and the inner wall 32 of the cylinder chamber 31 and between the first inclined surface 112 and the inner wall 32 of the cylinder chamber 31. Because the first protruding surface 21 and the first inclined surface 112 are arranged in a shape of V, a central area of the piston body 10 does not contact with the inner wall 32 of the cylinder chamber 31, so that a gap 40 is formed by the first protruding surface 21, the first inclined surface 112 and the inner wall 32 of the cylinder chamber 31, thereby reducing the friction resistance of the reciprocating movement of the piston body 10 in the cylinder chamber 31.

In which, the outer wall 11 of the piston body 10 is annular and extends in a direction of the central axis of the piston body 10.

The existing cylindrical piston is required to have desirable concentricity, cylindricity and diameter to match with the cylinder chamber, such that good sealing is realized between the cylindrical piston and the inner wall of the cylinder chamber, which require high accuracy for the manufacture. However, in practice, processing errors in the manufacturing process often cause insufficient sealing between the cylindrical piston and the inner wall of the cylinder chamber. In particular, front and rear ends of the cylindrical piston fail to contact the inner wall of the cylinder chamber, which leads to small gaps between the cylindrical piston and the inner wall of the cylinder chamber, resulting in issues that the cylinder has poor sealing and thus the leakage occurs.

The piston of the present embodiment realizes good sealing mainly because the first protruding surface 21 of the skirt 2 can elastically abut against the inner wall 32 of the cylinder chamber 31, which requires low accuracy for the manufacture. In addition, the first protruding surface 21 has greater elastic deformation in the radial direction due to the presence of the gap 40, so that the close fit between the first protruding surface 21 and the inner wall 32 of the cylinder chamber 31 is more easily realized. Assuming that the inner wall of the cylinder chamber is straight in a direction of its central axis and the outer wall of the piston body abuts against the inner wall of the cylinder chamber, contact points between the outer wall of the piston body and the inner wall of the cylinder chamber are on a straight line. However, due to the machining accuracy, the contact points between the outer wall of the piston body and the inner wall of the cylinder chamber generally fail to be on a straight line, that is, at least one contact point protrudes, at this time, a tiny gap is formed between the outer wall of the piston body and the inner wall of the cylinder chamber, resulting in poor sealing. In the present embodiment, both of the first protruding surface 21 and the first inclined surface 112 elastically abut against the inner wall 32 of the cylinder chamber 31, while a central area of the outer wall 11 of the piston body 10 does not contact the inner wall 32 of the cylinder chamber 31 due to the presence of the gap 40, so that the first protruding surface 21 and the first inclined surface 112 abut against the inner wall 32 of the cylinder chamber 31 on a line with two contact points. Therefore, the central axis of the piston body 10 is automatically aligned with a central axis of the cylinder chamber 31, that is, the piston of the present application can be automatically centered.

In an embodiment, as shown in FIGS. 1, 2 and 4, the outer wall of the piston body 10 further includes a second inclined surface 111 arranged between the first protruding surface 21 and the first inclined surface 112. The gap 40 is formed by the first protruding surface 21, the second inclined surface 111, the first inclined surface 112 and the inner wall 32 of the cylinder chamber 31. A first angle C is formed by the second inclined surface 111 and the first inclined surface 112. A second angle G is formed by the first inclined surface 112 and the central axis of the piston body 10. The second protruding surface 111 and the first inclined surface 112 are arranged in a shape of V, that is, a central area of the outer wall 11 of the piston body 10 is recessed toward a center of the piston body 10 to form a V shape. In this way, when the piston body 10 is installed in the cylinder chamber 31, the central area of the outer wall 11 of the piston body 10 does not contact the inner wall 32 of the cylinder chamber 31, so that a gap 40 is formed by the outer wall 11 of the piston body 10 and the inner wall 32 of the cylinder chamber 31, reducing the frictional resistance of the reciprocating movement of the piston body 10 in the cylinder chamber 31.

In an embodiment, as shown in FIG. 2, the first angle C is greater than 60° and less than 180° such that the second protruding surface 111 and the first inclined surface 112 can better avoid the contact with the inner wall 32 of the cylinder chamber 31 during the movement, so as to avoid the friction. The second angle G is greater than 5° and less than 90° such that the first inclined surface 112 abuts against the inner wall 32 of the cylinder chamber 31, thereby forming a sealing at the end of the first inclined surface 112.

In an embodiment, as shown in FIGS. 1, 2 and 4, an end of the piston body 10 close to the first inclined surface 112 is recessed to form a pressure chamber 12 that is U-shaped. A third inclined surface 13 is circumferentially provided in the pressure chamber 12 along the radial direction of the piston body 10. When the piston body 10 moves under pressure, high-pressure fluid in the pressure chamber 9 radially outward presses the third inclined surface 13, which forms a closer contact between the first inclined surface 112 and inner wall 32 of the cylinder chamber 31, that is, the greater the pressure of the high-pressure fluid, the better the sealing performance of the first inclined surface 112.

In an embodiment, as shown in FIG. 2, the third inclined surface 13 leans in the same direction as the first inclined surface 112. The third inclined surface 13 and the first inclined surface 112 can be, but not necessarily parallel. The third inclined surface 13 can be, but not necessarily include multiple sections.

In an embodiment, a thickness H of a wall formed by the third inclined surface 13 and the first inclined surface 112 is greater than 0.1 mm, so that the first inclined surface 112 has enough structural strength, and first inclined surface 112 and the inner wall 32 of the cylinder chamber 31 are in sealed contact.

In an embodiment, as shown in FIGS. 1, 2 and 4, the skirt 20 further includes a second protruding surface 22 which extends outward along a radial direction of the piston body 10. An end of the second protruding surface 22 away from the piston body 10 is connected to an end of the first protruding surface 21 away from the second inclined surface 111. A cross section of the skirt 20 in the direction of its central axis may be triangular, quadrangular, semicircular and elliptical. Preferably, the skirt 20 has a triangular cross section in the direction of its central axis. The third angle A formed by the first protruding surface 21 and the second protruding surface 22 is greater than 15° and less than 75°, so as to ensure good air tightness during the reciprocating movement of the piston body 10. The up-and-down motion of the piston body 10 forms negative pressure in the cylinder chamber 31. Because the skirt 20 consistently and elastically abuts against the inner wall 32 of the cylinder chamber 31, air is maintained outside the cylinder chamber 31 and fails to be mixed with the fluid in the cylinder chamber 31, thereby improving the operation stability and the service life of the high-pressure pumping system and reducing failure risk during the operation.

In an embodiment, a width of the skirt 20 in the direction of the central axis of the piston body 10 is greater than 0.01 mm. However, the second inclined surface 111 cannot be completely covered by the skirt 20 to ensure the existence of the gap 40.

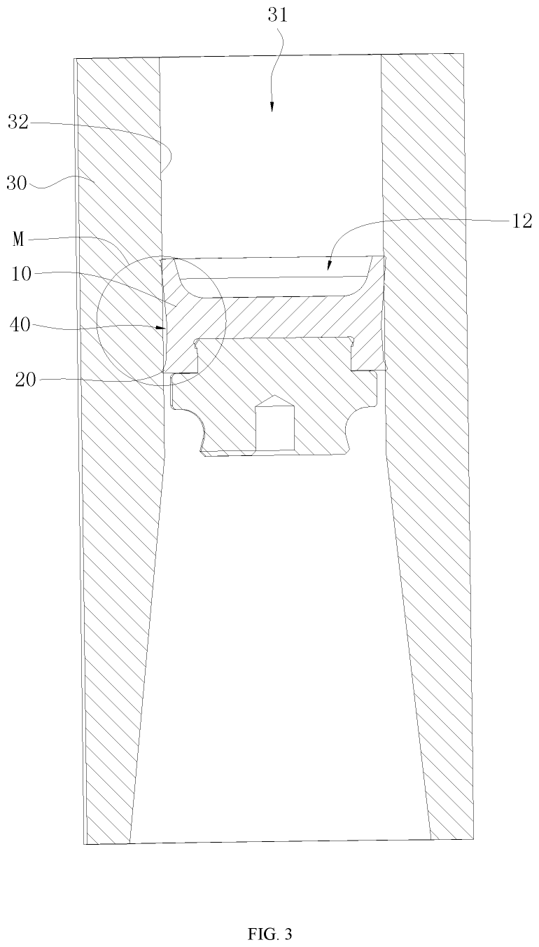

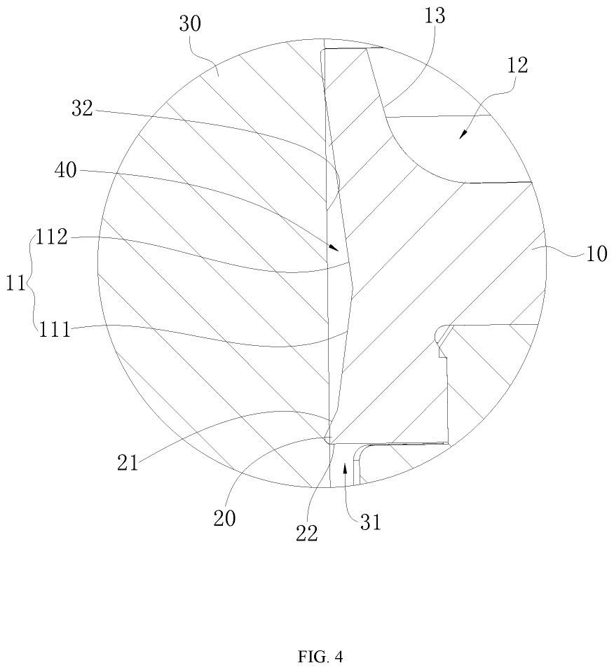

In an embodiment, a high-pressure pumping system is provided. As shown in FIGS. 3-4, the high-pressure pumping system includes a cylinder 30 and the piston mentioned above. The piston is received in the cylinder 30, and reciprocates with respect to the inner wall 32 of the cylinder chamber 31. The skirt 20 elastically abuts against the inner wall 32 of the cylinder chamber 31 when the piston is placed in the cylinder chamber 31.

In the present application, the high-pressure pumping system uses the piston of the present application to realize good sealing during the operation of the high-pressure pumping system, and the air is stopped from entering the cylinder chamber 31 to mix with the fluid therein, thereby improving the operation stability and the service life of the high-pressure pumping system and reducing failure risk during the operation.

In addition, the terms “first”, “second” and the like in the present application are for illustration purpose and not limited thereto. These terms are merely intended to distinguish the same type of information from each other. For example, without departing from the scope of the present application, “first” may refer to “second”, and similarly, “second” may refer to “first”.

The above description is only the preferred embodiments of the present application. It should be pointed out that any improvements and replacements made by those skilled in the art without departing from the technical principles of the present application shall fall within the scope of the present application.

What is claimed is:

1. A piston, comprising a piston body and a skirt;
wherein the skirt is elastic and peripherally provided at an end of the piston body; and the skirt elastically abuts against an inner wall of a cylinder chamber when the piston is placed in the cylinder chamber.

2. The piston of claim 1, wherein the piston body is elastic; an outer wall of the piston body comprises a first inclined surface; the skirt has a first protruding surface; an end of the first protruding surface is connected to an end of the first inclined surface; the other end of the first protruding surface obliquely extends outwards along a radial direction of the piston body; the other end of the first inclined surface obliquely extends outwards along the radial direction of the piston body; both of the first protruding surface and the first inclined surface elastically abut against the inner wall of the cylinder chamber; and a gap is formed by the first protruding surface, the first inclined surface and the inner wall of the cylinder chamber.

3. The piston of claim 1, wherein the piston body is elastic; an outer wall of the piston body comprises a first inclined surface and a second inclined surface; the skirt has a first protruding surface; the second inclined surface is arranged between the first protruding surface and the first inclined surface; the first protruding surface obliquely extends outwards along a radial direction of the piston body; the first inclined surface obliquely extends outwards along the radial direction of the piston body; both of the first protruding surface and the first inclined surface elastically abut against the inner wall of the cylinder chamber; the gap is formed by the first protruding surface, the second inclined surface, the first inclined surface and the inner wall of the cylinder chamber; a first angle is formed by the second inclined surface and the first inclined surface; and a second angle is formed by the first inclined surface and a central axis of the piston body.

4. The piston of claim 3, wherein the first angle is greater than 60° and less than 180°; and the second angle is greater than 5° and less than 90°.

5. The piston of claim 3, wherein a pressure chamber is provided at the other end of the piston body and is recessed; and a third inclined surface is circumferentially provided in the pressure chamber.

6. The piston of claim 5, wherein the third inclined surface and the first inclined surface are tilted in the same direction.

7. The piston of claim 5, wherein a thickness of a wall formed by the third inclined surface and the first inclined surface is greater than 0.1 mm.

8. The piston of claim 3, wherein the skirt further has a second protruding surface which extends outward along the radial direction of the piston body; and an end of the second protruding surface away from the piston body is connected to an end of the first protruding surface away from the second inclined surface.

9. The piston of claim 8, wherein a width of the skirt along a central axis of the piston body is greater than 0.01 mm.

10. A high-pressure pumping system, comprising a cylinder and the piston of claim 1;
wherein the piston is received in the cylinder and reciprocates with respect to the inner wall of the cylinder chamber; and the skirt elastically abuts against the inner wall of the cylinder chamber when the piston is placed in the cylinder chamber.

11. A high-pressure pumping system, comprising a cylinder and the piston of claim 2;
wherein the piston is received in the cylinder and reciprocates with respect to the inner wall of the cylinder chamber; and the skirt elastically abuts against the inner wall of the cylinder chamber when the piston is placed in the cylinder chamber.

12. A high-pressure pumping system, comprising a cylinder and the piston of claim 3;
wherein the piston is received in the cylinder and reciprocates with respect to the inner wall of the cylinder chamber; and the skirt elastically abuts against the inner wall of the cylinder chamber when the piston is placed in the cylinder chamber.

13. A high-pressure pumping system, comprising a cylinder and the piston of claim 4;
wherein the piston is received in the cylinder and reciprocates with respect to the inner wall of the cylinder chamber; and the skirt elastically abuts against the inner wall of the cylinder chamber when the piston is placed in the cylinder chamber.

14. A high-pressure pumping system, comprising a cylinder and the piston of claim 5;
wherein the piston is received in the cylinder and reciprocates with respect to the inner wall of the cylinder chamber; and the skirt elastically abuts against the inner wall of the cylinder chamber when the piston is placed in the cylinder chamber.

15. A high-pressure pumping system, comprising a cylinder and the piston of claim 6;
wherein the piston is received in the cylinder and reciprocates with respect to the inner wall of the cylinder chamber; and the skirt elastically abuts against the inner wall of the cylinder chamber when the piston is placed in the cylinder chamber.

16. A high-pressure pumping system, comprising a cylinder and the piston of claim 7;
wherein the piston is received in the cylinder and reciprocates with respect to the inner wall of the cylinder chamber; and the skirt elastically abuts against the inner wall of the cylinder chamber when the piston is placed in the cylinder chamber.

17. A high-pressure pumping system, comprising a cylinder and the piston of claim 8;
wherein the piston is received in the cylinder and reciprocates with respect to the inner wall of the cylinder chamber; and the skirt elastically abuts against the inner wall of the cylinder chamber when the piston is placed in the cylinder chamber.

18. A high-pressure pumping system, comprising a cylinder and the piston of claim 9;
wherein the piston is received in the cylinder and reciprocates with respect to the inner wall of the cylinder chamber; and the skirt elastically abuts against the inner wall of the cylinder chamber when the piston is placed in the cylinder chamber.
